(19) United States
(12) Patent Application Publication
(10) Pub. No.: US 2015/0134618 A1
(43) Pub. Date: May 14, 2015

(54) Techniques for Policy-Based Data Protection Services

(71) Applicants: Boris Teterin, Sunnyvale, CA (US); Santosh C. Lolayekar, Sunnyvale, CA (US); Pratik Murali, Sunnyvale, CA (US); Vinod Talati, Sunnyvale, CA (US)

(72) Inventors: Boris Teterin, Sunnyvale, CA (US); Santosh C. Lolayekar, Sunnyvale, CA (US); Pratik Murali, Sunnyvale, CA (US); Vinod Talati, Sunnyvale, CA (US)

(21) Appl. No.: 14/078,130

(22) Filed: Nov. 12, 2013

(51) Int. Cl. G06F 11/14

(52) U.S. Cl. CPC G06F 11/1412
USPC 707/654

(57) ABSTRACT

Examples are disclosed for a data protection service available to a tenant having access to a shared pool of configurable computing resources that may be included in a cloud computing network. In some examples, the tenant may be able to view backups and/or recover backed up data based on the one or more policies for the data protection service. The one or more policies may be generic to an application, a system or a configuration for the tenant to access and/or utilize the shared pool of configurable computing resources. Other examples are described and claimed.

### BACKGROUND

Advancements in network bandwidth available via such global public networks as the Internet or large enterprise-based Intranets have led to rapid growth in the use of pooled computing resources which may be shared among various users having access to these networks. These shared pools of configurable computing resources are sometimes referred to as cloud computing networks and may include, but are not limited to, various types of server farms, data centers or web hosting centers and in some examples also include applications running on these types of computing infrastructure. Users of shared pools of configurable computing resources may establish individual service level agreements (SLAs) with operators and/or owners of a cloud computing network which may enable a user to pay a fee to utilize a portion of the shared pool of configurable computing resources. The fee may be similar to renting a space on and/or a portion of the computing capacity for the shared pool of configurable computing resources. Since users may be renting space on and/or renting portions of the computing capacity, the users may sometimes be referred to as tenants.

Typically tenants may run various applications, systems or configurations on a shared pool of configurable computing resources. For example, a given tenant may be a financial institution that uses applications, systems or configurations consistent with financial services or banking operations. Meanwhile, another tenant may be retail merchant that uses applications, systems or configuration consistent with retail operations. Due to the various usage models of a shared pool of computing resources, administrators may need to balance centralized control with a tenant's desire for flexibility and applicability to their particular application need.

### BRIEF DESCRIPTION OF THE DRAWINGS

FIG. 1 illustrates an example first system.

FIG. 2 illustrates an example second system.

FIG. 3 illustrates an example process diagram.

FIG. 4 illustrates an example apparatus.

FIG. 5 illustrates an example logic flow.

FIG. 6 illustrates an example storage medium.

FIG. 7 illustrates an example computing platform.

### DETAILED DESCRIPTION

A tenant having a SLA to gain network access to a shared pool of computing resources via a network connection may be drawn to possible economic benefits of using the shared pool of computing resources. These economic benefits may include not having to own, maintain and continually upgrade computing resources to stay current with each computing evolution. However, a tradeoff may occur for tenants in terms of flexibility. A tenant may desire access to the shared pool of computing resources in a manner that may be both flexible and applicable to their particular usage model. However, an administrator of the shared pool of computing resources may need to balance centralized control of computing resources with the tenant's desire for flexibility and applicability to their usage model.

In some examples, the tenant may desire an application, system or configuration used for accessing and/or consuming the shared pool of computing resources to be dynamically deployable, stable, scalable and protected from possible resets, crashes, glitches or other issues at any time. The tenant may also want to maintain their particular application, system or configuration in a manner independent from the administrator of the cloud computing network. As a result of this independence, the tenant may desire services such as data protection services that are based on their unique organizational or business needs. However, since a cloud administrator may manage a shared pool of computing resources for numerous types of tenants having their own unique needs, this type of independence is problematic. Management complexity for the cloud administrator is increased and certain types of centrally-managed data protection services may not allow a given tenant to reach an expected Recovery Point Objective (RPO) or Recovery Time Objective (RTO) for an object associated with the application, system or configuration for the given tenant to access the shared pool of computing resources. It is with respect to these and other challenges that the examples described herein are needed.

In some examples, techniques for policy-based data protection services may be implemented. These techniques may include setting one or more policies for a data protection service available to a tenant having network access to a shared pool of configurable computing resources, e.g., included in a cloud computing network. For these examples, the one or more policies may be generic to an application, a system or a configuration for the tenant to access the shared pool of configurable computing resources. The techniques may also include provisioning the shared pool of configurable computing resources based, at least in part, on the one or more policies for the data protection service and then notifying the tenant of the one or more policies.

As described more below, data for an object associated with the application, the system or the configuration for the tenant to access the shared pool of configurable computing resources may be backed up and/or recovered according to the one or more set policies for the data protection service. According to some examples, recovered, backup data may then be used to restore the object to a consistent state or a recovery point. A tenant may be able to have at least some independence via viewing backup information and requesting a recovery of backup data based on the view. The data may then be recovered in accordance with the one or more set policies and provided to the tenant for the tenant to restore the object to the consistent state or the recovery point. In some other examples, the administrator may act on the tenant's behalf and restore the object to the consistent state or the recovery point.

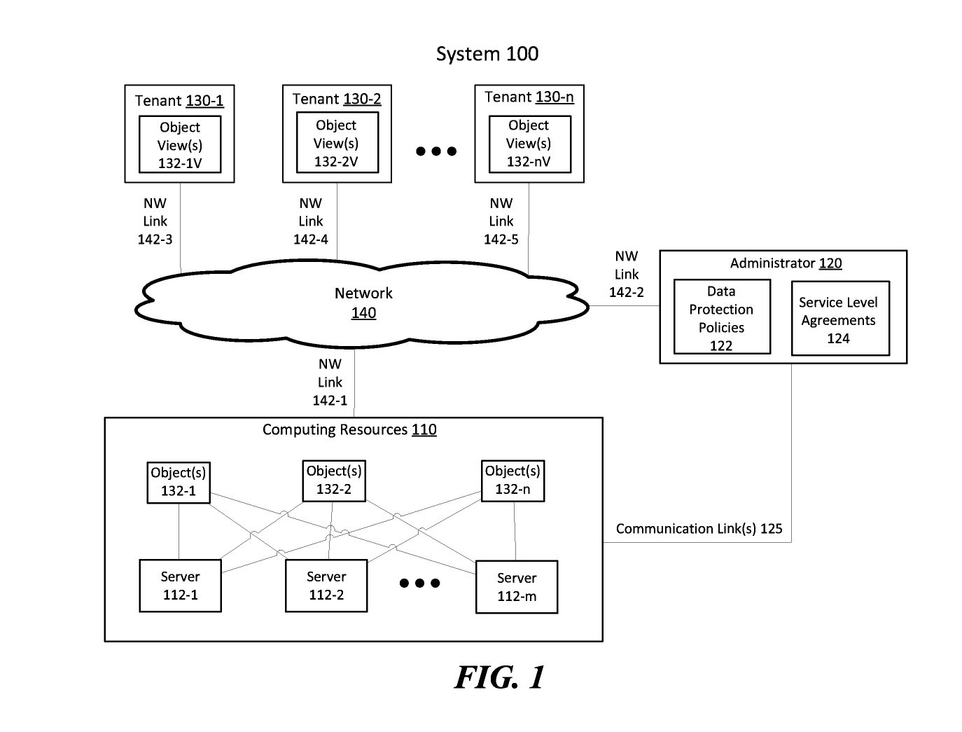

FIG. 1 illustrates an example first system. As shown in FIG. 1, the first system includes system 100. According to some examples, as shown in FIG. 1, system 100 includes computing resources 110, an administrator 120, tenants 130-1 to 130-n, where n equals any positive whole integer greater than 2, and a network 140. Also, as shown in FIG. 1, computing resources 110, administrator 120 and tenants 130-1 to 130-n may communicatively couple to network 140 via network (NW) links 142-1 to 142-5, respectively.

In some examples, administrator 120 may include logic and/or features to manage, control or direct a shared pool of computing resources included in computing resources 110. The shared pool of computing resources may include, but is not limited to, servers 112-1 to 112-m, where m equals any positive whole integer greater than 2. Although not shown in FIG. 1, servers 112-1 to 112-m may also include types of storage resources that are described in more detail below. Administrator 120 may manage, control or direct the shared pool of computing resources included in computing resources 110 through network 140 and/or through communication link(s) 125. Communication link(s) 125 may include, but are not limited to, one or more direct communication links to either an individual server from among servers 112-1 to 112-m or to groups of servers from among servers 112-1 to 112-m (e.g., included in local access networks (LANs) and/or grouped in a physical or virtual rack system).

According to some examples, although not shown in FIG. 1, administrator 120 may be integrated with or resident on at least one server included in computing resources 110. For these examples, administrator 120 may communicate with tenants 130-1 to 130-n via NW link 142-1. Administrator 120 may also manage, control or direct servers 112-1 to 112-m through one or more internal communication links that may include direct communication links or NW communication links via a LAN.

In some examples, tenants 130-1 to 130-n may have established separate SLAs with administrator 120 to access one or more servers 112-1 to 112-m. These separate SLAs may be maintained at or with administrator 120 and may be included in service level agreements 124. Service level agreements 124 may include information that defines a given tenant's ability to access computing resources 110 to host tenant objects such as tenant object 132-1, 132-2, 131-n for respective tenants 130-1, 130-2 and 13-n. As shown in FIG. 1, in some examples, object view(s) 132-1V to 131-nV at tenants 130-1 to 130-n depicts how objected 132-1 to 132-n hosted or supported by computing resources 110 may be viewed by tenants 130-1 to 130-n (e.g., viewed on a monitor at the physical location of a user associated with a given tenant).

Service level agreements 124 may also define a given tenant's ability to consume such services as services to protect data for an object associated with an application, system or configuration used by the given tenant to access computing resources 110. For example, data protection policies 122 may include either general data protection policies for all tenants 130-1 to 130-n to protect data for respective object(s) 132-1 to 132-n or separate data protection policies for each tenant may be included in data protection policies 122.

According to some examples, the data protection policies 122 may be generic to an application, system or configuration for tenants 130-1 to 130-n to access computing resources 110 through network 140. In other words, the data protection policies may establish boundaries or parameters to protect data for objects 132-2 to 132-n that allows for protection of the data that is generic or agnostic to the types of applications, systems or configurations used by tenants 130-1 to 130-n to access computing resources 130. For example, tenant 130-1 may be a financial services tenant using an application, system or configuration typically used by financial services organizations. Meanwhile tenant 130-2 may be an engineering services tenant having an application, system or configuration typically used by engineering firms. Data protection policies 122 may be generic to the applications, systems or configurations used by these different types of tenants.

According to some examples, computing resources 110 may be administered or managed by administrator 120 as part of a cloud computing network that may have servers 112-1 to 112-m located in a same location/building or geographically dispersed in a plurality of locations. Cloud computing resources 110 may be accessible to both tenants 130-1 to 130-n or administrator 120 through network 140 that may include a public network such the Internet or private network such as an enterprise intranet. The cloud computing network may operate in various modes to include, but not limited to, software as a service (SaaS), platform as a service (PaaS) or infrastructure as a service (IaaS). Also, tenants 130-1 to 130-n may have shared or provisioned use of computing resources 110 according to various deployment modes to include, but not limited to, a private cloud computing network, a community cloud computing network, a public cloud computing network or a hybrid cloud computing network.

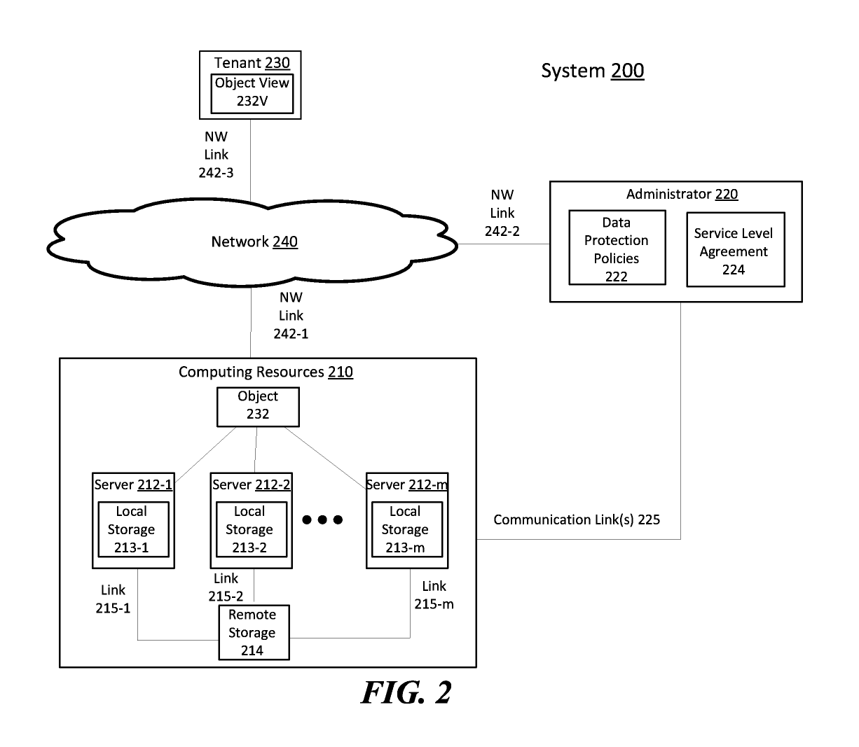

FIG. 2 illustrates an example second system. As shown in FIG. 2, the second system includes system 200. According to some examples, as shown in FIG. 2, system 200 includes computing resources 210, administrator 220 and tenant 230 coupled through network 240 via NW links 242-1, 242-2 and 242-3, respectively. Also, similar to system 100, administrator 220 may include logic and/or features to manage, control or direct a shared pool of computing resources included in computing resources 210. The shared pool of computing resources may include, but is not limited to, servers 212-1 to 212-m and these servers may couple to administrator 220 through network 240 or via one or more direct communication links included in communication link(s) 225. Similar to system 100, computing resources 210 may be administered or managed by administrator 220 as part of a cloud computing network.

According to some examples, as shown in FIG. 2, servers 212-1 to 212-m each include local storage 213-1 to 213-m, respectively. For these examples, local storage 213-1 to 213-m, may separately serve as local, primary storage locations for their respective server. Servers 212-1 to 212-m may also be coupled to a remote storage 214 via links 215-1 to 215-m, respectively. Remote storage 214 may serve as a remote, secondary storage location for servers 212-1 to 212-m. As mentioned more below, in some examples, data protection policies 222 and/or service level agreement 224 may dictate how computing resources 210 are provisioned and ultimately how data may be backed up to a local, primary location (e.g., local storage 213-1) or remote, secondary storage location (e.g., remote storage 214).

In some examples, local, primary storage included in local storage 213-1, 213-2 or 213-m may include types of storage devices that may include storage mediums or devices having relatively low access latencies to backup or recover data. The access latencies may be based on such factors as the type of storage medium (e.g., solid state drive and/or non-volatile memory cache) or allocated bandwidth/resources available for accessing the local, primary storage.

According to some examples, remote, secondary storage included in remote storage 214 may include types of storage devices that may have relatively high access latencies to backup or recover data. The access latencies may be based on a remote location or multiple remote locations and also may be based on the types of storage medium such as a hard disk drive or tape that may have high access latencies to retrieve data from the given remote location(s).

In some examples, administrator 220 may set data protection policies 222 for a data protection service available to tenant 230 having network access to computing resources 210 through network 240. The data protection service available to tenant 230 may have been established via an SLA between tenant 230 and administrator 220. This SLA may be included in service level agreement 224. For these examples, data protection policies 222 may be generic to an application, a system or a configuration for tenant 230 to access computing resources 210.

According to some examples, data protection policies for the data protection service available to tenant 230 may also include placing some limits such as, but not limited to, a limit on a number of backups allowed over a given period of time, a limit to a number of recoveries over a given period of time or an amount of computing resource utilization that may be tied to storage and/or computing performance impacts.

In some examples, the SLA between tenant 230 and administrator 220 may also include some specific data protection policies tailored to tenant 230. For these examples, tenant 230 may arrange for and/or pay for higher levels of data protection than what may be possible via generic data protection policies. For example, tenant 230 may want only primary, local storage for data backup due to possible needs to reach a recovery point or a consistent state with the least amount of delay. Administrator 220 may utilize a hierarchical scheme that looks first to specific/tailored data protection policies arranged for in the SLA with tenant 230 but may revert to generic data protection policies if administrator 220 is not able to meet minimum requirements to satisfy generic data protection polices for all tenants. In other words, resolution of conflicts between specific/tailored data protection policies and meeting SLAs for other tenants having generic data protection policies may result in the needs of all tenants trumping the needs of a specific tenant.

According to some examples, logic and/or features of administrator 220 may be capable of provisioning at least portions of computing resources 210 based, at least in part, on data protection policies 222. For example, data for object 232 associated with the application, the system or the configuration for tenant 230 to access computing resources 210 may be backed up based on various methods or schemes included in data protection policies 222. The various methods or schemes may include tenant 230 having an ability to request or cause various types of data backup to include, but not limited to, on-demand backup, scheduled backup, mirroring backed up data to a local, primary storage location (e.g., local storage 213-1) or minoring backup data to a remote, secondary storage location (e.g., remote storage 214). Depending on which of these methods or schemes are included in data protection policies 222, administrator 220 may provision computing resources 210 or cause computing resources 210 to be provisioned to support the included methods or schemes.

In some examples, data protection policies 222 may also include methods or schemes to recover data for object 232 hosted by servers 212-1 212-2 or 212-n that may have already been backed up. For example, backed up data may be recovered from at least one of a local, primary storage location or a remote, secondary storage location. For these examples, computing resources 210 may be provisioned to accommodate or support either or both of these recovery methods. According to some examples, recovering from a local, primary storage location may be desired by tenant 230 if a relatively fast recovery is needed and the data has to be quickly available to restore object 232 to a recovery point or a consistent state. Recovering from the local, primary storage location may require a more expensive resource provisioning (e.g., utilizes a more costly type of storage medium) and tenant 230 may pay a higher fee. In other examples, recovering from a remote, secondary storage location may be desired by tenant 230 due to cost factors and possibly reduced need to quickly restore object 232 to a recovery point or a consistent state. For these other examples, less expensive resource provisioning may be needed to service these less time intensive recoveries of data. The less expensive resource provisioning may include distributing storage among various remote storage locations and/or primarily using lower cost storage mediums (e.g., hard disk drives).

According to some examples, once administrator 220 has provisioned computing resources 210 to support data protection policies 222, tenant 230 may be notified what data protection policies included in data protection policies 222 are available to tenant 230. Data for object 232 may then be backed up, for example, to a combination of local storage 213-1 at server 212-1 and to remote storage 214.

In some examples, administrator 220 may monitor tenant 230's utilization of local storage 213-1 at server 212-1 or remote storage 214. The data protection policies included in data protection policies 222 may then be modified based on the monitored utilization rate. For example, the data protection policies may include on-demand backing up of data. A given amount of storage capacity for local storage 213-1 may have been provisioned to support the on-demand backing up of data. However, the actual monitored utilization rate may indicate a lower-than-expected use of on-demand data protection services. As a result, the data protection policies may be modified to cause a lower amount of storage capacity for local storage 213-1 to be used for on-demand backing up of data. Local storage 213-1 may then be re-provisioned to a smaller amount of storage capacity to support the modified data protection policies. Administrator 220 may then notify tenant 230 of the modified data protection policies.

According to some examples, administrator 220 may revoke or modify tenant 230's ability to access computing resources 210. For example, tenant 230 may have violated terms of an SLA included in service level agreement 224 (e.g., failure to pay for services or exceeding backup limits). Administrator 220 may be capable of either temporarily revoking tenant 230's ability to access computing resources 210 until tenant 230 comes within compliance with the SLA or permanently revoking tenant 230's ability to access computing resources 210.

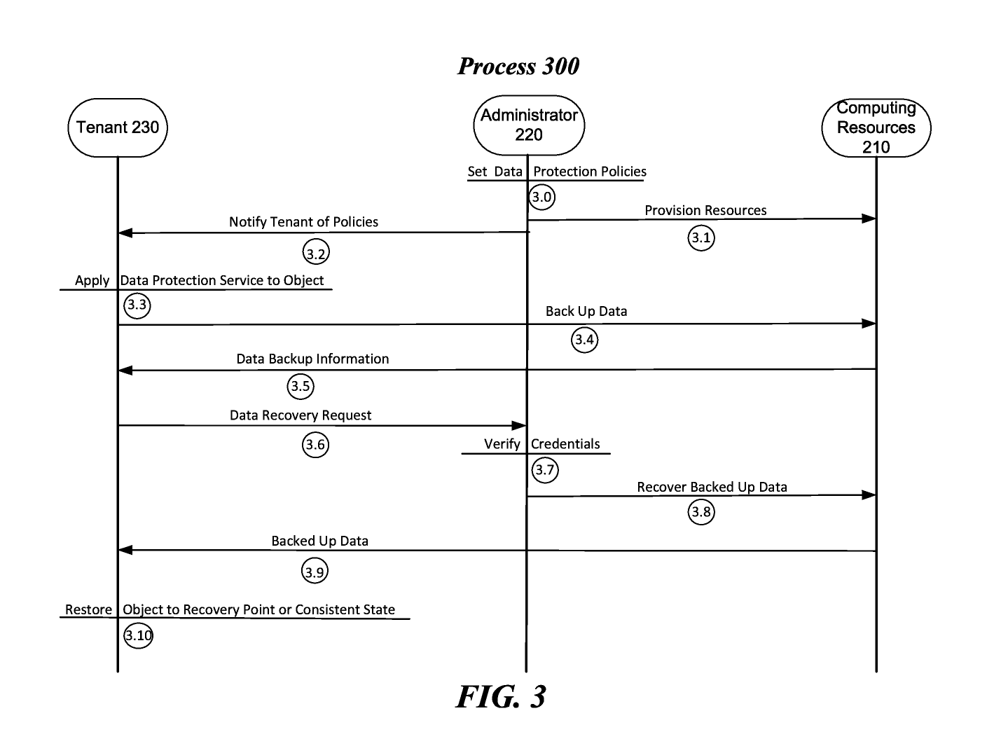

FIG. 3 illustrates an example process 300. In some examples, process 300 may be for a an administrator of a shared pool of configurable computing resources to set one or more policies for a data protection service available to a tenant having network access to the shared pool of configurable computing resources. For these examples, elements of system 200 as shown in FIG. 2 may be used to illustrate example operations related to process 300. However, the example operations are not limited to implementations using elements of system 200.

Beginning at process 3.0 (Set Data Protection Polices), logic and/or features at administrator 220 may set one or more data protection policies for a data protection service available to tenant 230. In some examples, the one or more policies may be generic to an application, a system or a configuration for tenant 230 to access computing resources 210. The one or more policies may also include some specific data protection polices for tenant 230 that may allow for additional data protection (e.g., use of only primary, local storage for data backup).

Proceeding to process 3.1 (Provision Resources), logic and/or features at administrator 220 may provision computing resources 210 based, at least in part, on the one or more polices for the data protection service.

Proceeding to process 3.2 (Notify Tenant of Policies), logic and/or features at administrator 220 may notify tenant 230 of the one or more data protection policies. The notification may include information to include a scheduler which may indicate to tenant 230 defined time frames for backing up data in a manner consistent with how computing resources 210 may have been provisioned.

Processing to process 3.3 (Apply Data Protection Service to Object), logic and/or features at tenant 230 may be capable of applying the data protection service to an object associated with the application, the system or the configuration for tenant 230 to access computing resources 210. In some examples, the object may include object 232 and applying the one or more data protection policies may include requesting on-demand backups of data for object 232 that may be associated with one or more recovery points. Applying the one or more data protection policies may also include requesting the backup data be mirrored to a local or a remote storage location in order to provide an added level of data protection. Applying the one or more data protection policies may also include selecting a given time frame among possibly multiple time frame options for backing up data. These time frame options may have been included in the notification received from administrator 220.

Proceeding to process 3.4 (Backup Data), logic and/or features at administrator 220 may cause data for the object to be backed up to computing resources 210. According to some examples, the data backup may be caused and/or performed by administrator 220 according to the one or more data protection policies for the data protection service applied to the object by tenant 230.

Proceeding to process 3.5 (Data Backup Information), logic and/or features at administrator 220 may provide data backup information to tenant 230. In some examples, the data backup information may enable logic and/or features at tenant 230 to present a view of data backup(s) for the object (e.g., object 232) to a user located at or with tenant 230. The data backup information may depict one or more recovery points that may have been created according to the applied data protection service that may enable tenant 230 to restore object 232 to a given recovery point or to a consistent state. The data backup information may also indicate which servers from among computing resources 210 are maintaining or storing the backed up data or whether the data is being locally or remotely stored.

Proceeding to process 3.6 (Data Recovery Request), logic and/or features at tenant 230 may place or initiate a recovery request to administrator 220 via a recovery request. According to some examples, the recovery request may be initiated based on the viewed data backup as mentioned above. For example, a user at tenant 230 may wish to restore the object to a given recovery point viewed based on the received data backup information.

Proceeding to process 3.7 (Verify Credentials), logic and/or features at administrator 220 may verify credentials of tenant 230 before completing the recovery request. In some examples, the credentials may be based on an SLA that may list types of recovery requests that may or may not be allowed for tenant 230 or limits placed on numbers of backups, timing of backs or resources utilized for backups. For example, tenant 230 may have credentials to request backup data from primary, local storage locations if the time between the original storing of the data has not elapsed to a point to where the data is no longer maintained in primary, local storage locations and is instead maintained in secondary, remote storage locations. The time elapse, for example, may also be indicated in the one or more data protection policies. In some other examples, tenant 230's credentials may have been revoked due to failure to make timely payments for services. For these other examples, administrator 220 may deny the recovery request due to this revocation.

Proceeding to process 3.8 (Recover Backed Up Data), logic and/or features at administrator 220 may recover backed up data from computing resources 230 according to the one or more data protection policies.

Proceeding to process 3.9 (Backed Up Data), logic and/or features at administrator 220 may provide the recovered backed up data to tenant 230. In some examples, tenant 230 may then restore the object to the given recovery point viewed based on the received data backup information or restore the object to a previous consistent state.

Proceeding to process 3.10 (Restore Object to Recovery Point or Consistent State), logic and/or features at tenant 230 may restore the object to a recovery point or a consistent state. According to some examples, tenant 230 may restore the object to the given recovery point or a consistent state. The given recovery point or consistent state may be associated with a specific instance for the application, the system or the configuration used by tenant 230 to access computing resources 210. That specific instance may be associated with a given time before a malfunction, glitch, forced reset or intentional reset necessitated a need for the application, the system or the configuration to be restored to the given recovery point or consistent state.

In some examples, although not shown in FIG. 3 for process 300, rather than tenant 230 restoring the object to the given recovery point or consistent state, administrator 220 may be capable of determining whether backed up data is needed to restore the object to the given recovery point or consistent state. For these examples, administrator 220 may also be capable of then recovering the backed up data and use the backed up data to restore the object to the given recovery point or consistent state on behalf of tenant 230. Thus, administrator 220 may provide a data protection service that may be somewhat automated and may require little involvement from tenant 230 to restore the object due to a malfunction, glitch, forced reset or intentional reset.

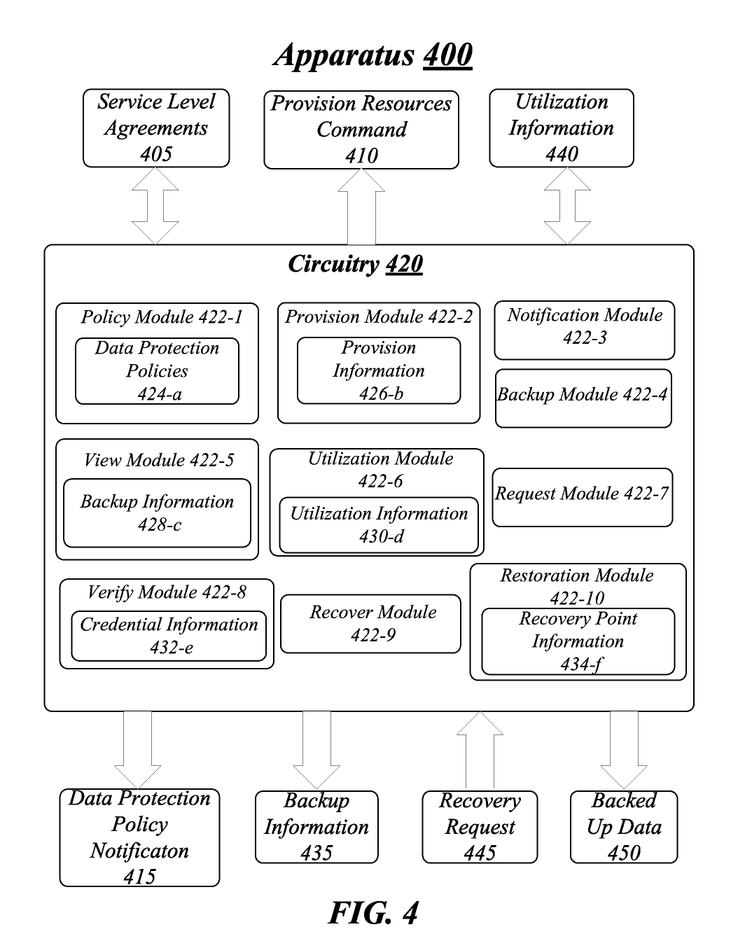

FIG. 4 illustrates a block diagram for an apparatus 400. Although apparatus 400 shown in FIG. 4 has a limited number of elements in a certain topology or configuration, it may be appreciated that apparatus 400 may include more or less elements in alternate configurations as desired for a given implementation.

The apparatus 400 may comprise a computer and/or firmware implemented apparatus 400 having a circuitry 420 arranged to execute one or more software and/or firmware modules 422-a. It is worthy to note that “a” and “b” and “c” and similar designators as used herein are intended to be variables representing any positive integer. Thus, for example, if an implementation sets a value for a=10, then a complete set of modules 422-a may include modules 422-1, 422-2, 422-3, 422-4, 422-5, 422-6, 422-7, 422-8, 422-9 or 422-10. The embodiments are not limited in this context.

According to some examples, apparatus 400 may be capable of being located with a computing device that may host an administrator of a shared pool of computing resources. For example, the computing device having apparatus 400 may be arranged or configured to manage or control computing resources included in a cloud computing network and may set one or more policies for a data protection service available to tenants having access to the cloud computing network. The examples are not limited in this context.

In some examples, as shown in FIG. 4, apparatus 400 includes circuitry 420. Circuitry 420 may be generally arranged to execute one or more modules 422-a. Circuitry 420 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Dual microprocessors, multi-core processors, and other multi-processor architectures may also be employed as circuitry 420. According to some examples circuitry 420 may also be an application specific integrated circuit (ASIC) and modules 422-a may be implemented as hardware elements of the ASIC.

According to some examples, apparatus 400 may include a policy module 422-1. Policy module 422-1 may be executed by circuitry 420 to set one or more policies for a data protection service available to a tenant having network access to a shared pool of configurable computing resources included in a cloud computing network (e.g., shared with other tenants having network access). The one or more policies may be generic to an application, a system or a configuration for the tenant to access the shared pool of configurable computing resources. In some examples, some additional polices may be arranged with a particular tenant that may choose to pay more for additional data protection services. According to some examples, policy module 422-2 may maintain data protection policies 424-a in a data structure such as a lookup table (LUT)

In some examples, apparatus 400 may also include a provision module 422-2. Provision module 422-2 may be executed by circuitry 420 to provision the shared pool of configurable computing resources based, at least in part, on the one or more policies for the data protection service. For these examples, provision 422-2 may send a provision resources message to at least some of the shared pool of configurable computing resources to cause the provisioning that may be included in provision resources command 410. Also, provision module 422-2 may maintain provision information 426-b in a data structure such as a LUT to keep track of this provisioning.

According to some examples, apparatus 400 may also include a notification module 422-3. Notification module 422-3 may be executed by circuitry 420 to notify the tenant of the one or more policies that had been set by policy module 422-1. The notification may be included in data policy notification 415.

In some examples, apparatus 400 may also include a backup module 422-4. Backup module 422-4 may be executed by circuitry 420 to backup data for an object associated with the application, the system or the configuration for the tenant to access the shared pool of configurable computing resources. The data backup may be performed by backup module 422-4 according to the one or more policies maintained by policy module 422-1 as data protection policies 424-a.

According to some examples, apparatus 400 may also include a view module 422-5. View module 422-5 may be executed by circuitry 420 to provide the tenant information to view the data backed up according to the one or more policies. For these examples, backup information 435 may be sent to the tenant to enable the view of the data backed up.

In some examples, apparatus 400 may also include a utilization module 422-6. Utilization module 422-6 may be executed by circuitry 420 to monitor a utilization rate of the provisioned shared pool of configurable computing resources based on utilization information 440 exchanged with at least some of the provisioned computing resources. For these examples, utilization module 422-6 may gather information associated with this monitoring in utilization information 430-2, which may be maintained in a data structure such as an LUT. Policy module 422-1, in some examples, may modify data protection policies 424-a based on the utilization rate. If data protection policies 424-a are modified, notification module 422-3 may notify the tenant of the modifications via a updated message included in data protection policy notification 415.

According to some examples, apparatus 400 may also include a request module 422-7. Request module 422-7 may be executed by circuitry 420 to receive a recovery request to recover data based on the information provided to the tenant to view the data backup. For these examples, the recovery request may be included in recovery request 445 received from the tenant.

In some examples, apparatus 400 may also include a verify module 422-8. Verify module 422-8 may be executed by circuitry 420 to verify tenant credentials to recover the data. For these examples, verify module 422-8 may maintain credential information 432-e (e.g., in a LUT) based on an SLA established with the tenant and included in service level agreements 405.

According to some examples, apparatus 400 may also include a recovery module 422-9. Recovery module 422-9 may be executed by circuitry 420 to recover the backed up data according to data protection policies 424-a maintained by policy module 422-1.

In some examples, apparatus 400 may also include a restoration module 422-10. Restoration module 422-10 may be executed by circuitry 420 to provide the backed up data to the tenant for the tenant to restore the object to a recovery point or a consistent state. For these examples, the backed up data may be provided to the tenant with backed up data 450.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

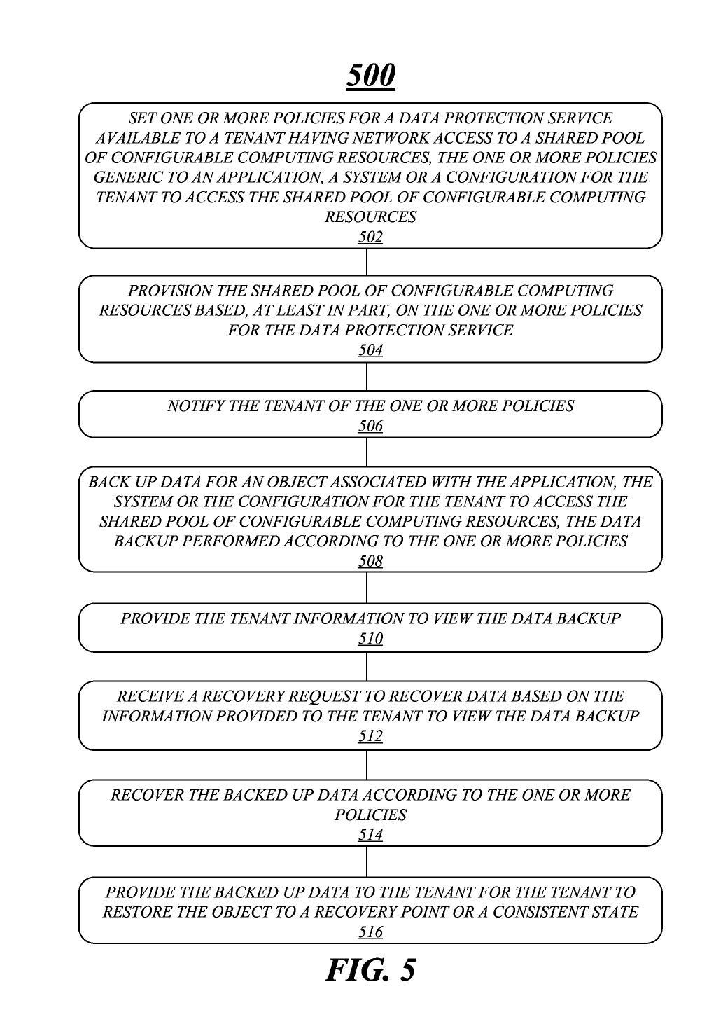

FIG. 5 illustrates a logic flow 500. Logic flow 500 may be representative of some or all of the operations executed by one or more logic, features, or devices described herein, such as apparatus 400. More particularly, logic flow 500 may be implemented by policy module 422-1, provision module 422-2, notification module 422-3, backup module 422-4, view module 422-5, utilization module 422-6, request module 422-7, verify module 422-8, recovery module 422-9 or restoration module 422-10.

According to some examples, logic flow 500 at block 502 may set one or more policies for a data protection service available to a tenant having network access to a shared pool of configurable computing resources. The one or more policies may be generic to an application, a system or a configuration for the tenant to access the shared pool of configurable computing resources. For example, policy module 422-1 may set the one or more policies for the data protection service.

In some examples, logic flow 500 at block 504 may provision the shared pool of configurable computing resources based, at least in part, on the one or more policies for the data protection service. For example, provision module 422-2 may cause at least some of the computing resources included in the shared pool to be provisioned to support the one or more policies for the data protection service.

According to some examples, logic flow 500 at block 506 may notify the tenant of the one or more policies. For example, notification module 422-3 may provide the notification to the tenant.

In some examples, logic flow 500 at block 508 may backup data for an object associated with the application, the system or the configuration for the tenant to access the shared pool of configurable computing resources, the data backup performed according to the one or more policies. For example, backup module 422-4 may cause at least a portion of the configurable computing resources to backup the data according to the one or more policies.

According to some examples, logic flow 500 at block 510 may provide the tenant information to view the data backup. For example, view module 422-5 may provide the information to view the data backup.

In some examples, logic flow 500 at block 512 may receive a recovery request to recover data based on the information provided to the tenant to view the data backup. For example, request module 422-6 may receive the recovery request from the tenant.

According to some examples, logic flow 500 at block 514 may recover the backed up data according to the one or more policies. For example, recover module 422-9 may recover the backed up data.

In some examples, logic flow 500 at block 516 may provide the backed up data to the tenant for the tenant to restore the object to a recovery point or a consistent state. For example, recover module 422-9 may provide the backed up data to the tenant. Also, in some examples, restoration module 422-10 may facilitate the tenant's restoration of the object.

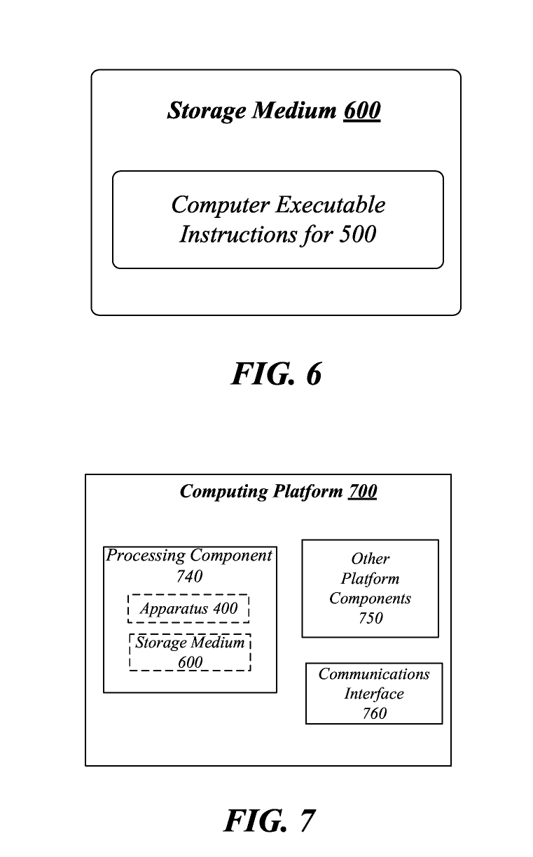

FIG. 6 illustrates an embodiment of a storage medium 600. The storage medium 600 may comprise an article of manufacture. In some examples, storage medium 600 may include any non-transitory computer readable medium or machine readable medium, such as an optical, magnetic or semiconductor storage. Storage medium 600 may store various types of computer executable instructions, such as instructions to implement logic flow 500. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 7 illustrates an example computing device 700. In some examples, as shown in FIG. 7, computing device 700 may include a processing component 740, other platform components 750 or a communications interface 760.

According to some examples, processing component 740 may execute processing operations or logic for apparatus 400 and/or computer readable medium 600. Processing component 740 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 750 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units associated with either other platform components 750 may include without limitation, various types of computer readable and machine readable storage media in the form of one or more higher speed memory units, such as ROM, RAM, DRAM, Double-Data-Rate DRAM (DDRAM), synchronous DRAM (SDRAM), SRAM, programmable ROM (PROM), EPROM, EEPROM, NAND flash memory, NOR flash memory, polymer memory such as ferroelectric polymer memory, ferroelectric transistor random access memory (FeTRAM or FeRAM), nanowire, ovonic memory, ferroelectric memory, 3-dimentional cross-point memory, SONOS memory, magnetic or optical cards, an array of devices such as Redundant Array of Independent Disks (RAID) drives, solid state memory devices (e.g., USB memory), SSDs and any other type of storage media suitable for storing information.

In some examples, communications interface 760 may include logic and/or features to support a communication interface. For these examples, communications interface 760 may include one or more communication interfaces that operate according to various communication protocols or standards to communicate over direct or network communication links. Direct communications may occur via use of communication protocols or standards described in one or more industry standards (including progenies and variants) to include the Peripheral Component Interconnect (PCI) Express Base Specification, revision 3.0, published in November 2010 (“PCI Express” or “PCIe”), the Universal Serial Bus Specification, revision 3.0, published in November 2008 (“USB”), the Serial ATA (SATA) Specification, revision 3.1, published in July 2001, Request for Comments (RFC) 3720, Internet Small Computer System Interface (iSCSI), published in April 2004 and/or the Serial Attached SCSI (SAS) Specification, revision 2.1, published in December 2010. Network communications may occur via use of various communication protocols and may operate in compliance with one or more promulgated standards or specifications for wired or wireless networks by the Institute of Electrical Engineers (IEEE). These standards are specifications may include, but are not limited to, IEEE 802.11-2012 Standard for Information technology—Telecommunications and information exchange between systems—Local and metropolitan area networks—Specific requirements Part 11: WLAN Media Access Controller (MAC) and Physical Layer (PHY) Specifications, published March 2012, later versions of this standard (“IEEE 802.11”) for wireless mediums or IEEE 802.3-2008, Carrier sense Multiple access with Collision Detection (CSMA/CD) Access Method and Physical Layer Specifications, Published in December 2008 (hereinafter “IEEE 802.3”) for wired mediums, one or more protocols that may encapsulate Fibre Channel frames over Ethernet networks referred to as fiber channel over Ethernet (FCoE), compatible with the protocols described by the American National Standard of Accredited Standards Committee INCITS T11 Technical Committee, Fibre Channel Backbone-5(FC-BB-5) Standard, Revision 2.0, published June 2009 and/or protocols associated with RFC 3530, Network File System (NFS), version 4 Protocol, published in April 2003.

Computing device 700 may be part of a system or device that may be, for example, user equipment, a computer, a personal computer (PC), a desktop computer, a laptop computer, a notebook computer, a netbook computer, a tablet computer, a tablet, a portable gaming console, a portable media player, a smart phone, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of computing device 700 described herein, may be included or omitted in various embodiments of computing device 700, as suitably desired.

The components and features of computing device 700 may be implemented using any combination of discrete circuitry, application specific integrated circuits (ASICs), logic gates and/or single chip architectures. Further, the features of computing device 700 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing device 700 shown in the block diagram of FIG. 7 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
setting one or more policies for a data protection service available to a tenant having network access to a shared pool of configurable computing resources, the one or more policies generic to an application, a system or a configuration for the tenant to access the shared pool of configurable computing resources;
provisioning the shared pool of configurable computing resources based, at least in part, on the one or more policies for the data protection service; and
notifying the tenant of the one or more policies.

2. The method of claim 1, comprising:
backing up data for an object associated with the application, the system or the configuration for the tenant to access the shared pool of configurable computing resources, the data backup performed according to the one or more policies;
providing information to enable the tenant to view the data backup;
receiving a recovery request to recover backed up data based on the information provided to the tenant to view the data backup;
verifying tenant credentials to recover the data;
recovering the backed up data according to the one or more policies; and
providing the backed up data to the tenant for the tenant to restore the object to a recovery point or a consistent state.

3. The method of claim 2, comprising the tenant credentials based on a service level agreement between the tenant and an administrator for the shared pool of configurable computing resources.

4. The method of claim 2, the one or more policies comprising on-demand backing up of data for the object, scheduled backing up of data for the object, minoring backup data to a local, primary storage location or mirroring backup data to a remote, secondary storage location.

5. The method of claim 4, comprising:
monitoring a utilization rate of the provisioned shared pool of configurable computing resources;
modifying the one or more policies based on the utilization rate; and
notifying the tenant of the modified one or more policies.

6. The method of claim 5, comprising:
the one or more policies including on-demand backing up of data and the utilization rate indicating one of a low frequency of on-demand backups initiated by the tenant or low amounts of data associated with on-demand backups initiated by the tenant; and
re-provisioning the shared pool of configurable computing resources based, at least in part, on the modified one or more policies such that less computing resources are provisioned to support the modified one or more policies.

7. The method of claim 2, recovering the backed up data according to the one or more policies comprises recovering the backed up data from at least one of a local, primary storage location or a remote, secondary storage location.

8. The method of claim 1, comprising:
backing up data for an object associated with the application, the system or the configuration used by the tenant to access the shared pool of configurable computing resources, the data backup performed according to the one or more policies;
determining that the backed up data is needed to restore the object to a recovery point or a consistent state;
recovering the backed up data according to the one or more policies; and
using the backed up data to restore the object to the recovery point or the consistent state.

9. The method of claim 1, the shared pool of configurable computing resources comprising a cloud computing network.

10. An apparatus comprising:
circuitry;
a policy module for execution by the circuitry to set one or more policies for a data protection service available to a tenant having network access to a shared pool of configurable computing resources, the one or more policies generic to an application, a system or a configuration for the tenant to access the shared pool of configurable computing resources;
a provision module for execution by the circuitry to provision the shared pool of configurable computing resources based, at least in part, on the one or more policies for the data protection service; and
a notification module for execution by the circuitry to notify the tenant of the one or more policies.

11. The apparatus of claim 10, comprising:
a backup module for execution by the circuitry to backup data for an object associated with the application, the system or the configuration for the tenant to access the shared pool of configurable computing resources, the data backup performed according to the one or more policies;
a view module for execution by the circuitry to provide the tenant information to view the data backup;
a request module for execution by the circuitry to receive a recovery request to recover data based on the information provided to the tenant to view the data backup;
a verify module for execution by the circuitry to verify tenant credentials to recover the data;
a recover module for execution by the circuitry to recover the backed up data according to the one or more policies; and
a restoration module for execution by the circuitry to provide the backed up data to the tenant for the tenant to restore the object to a recovery point or the consistent state.

12. The apparatus of claim 11, the one or more policies comprising backing up the data based on an on-demand tenant request for backing up data for the object, scheduled backing up of data for the object, mirrored backing up of data for the object to a local, primary storage location or mirrored backing up of data for the object to a remote, secondary storage location.

13. The apparatus of claim 11, comprising:
a utilization module for execution by the circuitry to monitor a utilization rate of the provisioned shared pool of configurable computing resources;
the policy module to modify the one or more policies based on the utilization rate; and
the notification module to notify the tenant of the modified one or more policies.

14. The apparatus of claim 10, comprising:
a backup module for execution by the circuitry to backup an object associated with the application, the system or the configuration for the tenant to access the shared pool of configurable computing resources, the data backup performed according to the one or more policies;
a recover module for execution by the circuitry to determine that the backed up data is needed to restore the object to a recovery point or a consistent state and then recover the backed up data according to the one or more policies; and
a restoration module for execution by the circuitry to recover the backed up data according to the one or more policies and use the backed up data to restore the object to the recovery point or the consistent state.

15. At least one machine readable medium comprising a plurality of instructions that in response to being executed by a system cause the system to:
set one or more policies for a data protection service available to a tenant having network access to a shared pool of configurable computing resources, the one or more policies generic to an application, a system or a configuration for the tenant to access the shared pool of configurable computing resources;
provision the shared pool of configurable computing resources based, at least in part, on the one or more policies for the data protection service;
notify the tenant of the one or more policies; and
backup data for an object associated with the application, the system or the configuration for the tenant to access the shared pool of configurable computing resources, the data backup performed according to the one or more policies.

16. The at least one machine readable medium of claim 15, comprising the instructions to cause the system to:
provide information to enable the tenant to view the data backup;
receive a recovery request to recover data based on the information provided to the tenant to view the data backup;
verify tenant credentials to recover the data;
recover the backed up data according to the one or more policies; and
provide the backed up data to the tenant for the tenant to restore the object to a recovery point or a consistent state.

17. The at least one machine readable medium of claim 16, the one or more policies comprising on-demand backing up of data for the object, scheduled backing up of data for the object, minoring backup data to a local, primary storage location or minoring backup data to a remote, secondary storage location.

18. The at least one machine readable medium of claim 17, comprising the instructions to cause the system to:
monitor a utilization rate of the provisioned shared pool of configurable computing resources;
modify the one or more policies based on the utilization rate; and
notify the tenant of the modified one or more policies.

19. The at least one machine readable medium of claim 15, comprising the instructions to cause the system to:
determine that the backed up data is needed to restore the object to a recovery point or a consistent state;
recover the backed up data according to the one or more policies; and
use the backed up data to restore the object to the recovery point or the consistent state.

20. The at least one machine readable medium of claim 19, the instruction to cause the system to recover the backed up data according to the one or more policies comprises recovering the backed data from at least one of a local, primary storage location or a remote, secondary storage location.

21. A method comprising:
receiving, at a tenant capable of accessing a shared pool of configurable computing resources, one or more policies for a data protection service provided by an administrator, the one or more policies arranged to be generic to an application, a system or a configuration used by the tenant to access the shared pool of configurable computing resources;
applying the data protection service to an object associated with the application, the system or the configuration based on the one or more policies;
receiving information to view a data backup for the object that was created according to the applied data protection services; and
initiating a data recovery based on the viewed data backup via a recovery request.

22. The method of claim 21, comprising:
receiving the data backup based on verification of credentials of the tenant by the administrator responsive to the administrator receiving the recovery request; and
using the data backup to restore the object to a recovery point or a consistent state.

23. The method of claim 21, comprising the data backup recovered by the administrator responsive to the recovery request based on the one or more policies to include recovering the backed up data from at least one of a local, primary storage location or a remote, secondary storage location.

24. The method of claim 21, the one or more policies comprising on-demand backing up of data for the object, scheduled backing up of data for the object, minoring backup data to a local, primary storage location or mirroring backup data to a remote, secondary storage location.

25. The method of claim 21, the shared pool of configurable computing resources comprises a cloud computing network and the administrator providing the data protection service comprises a cloud administrator.
